(19) United States
(12) Patent Application Publication
(10) Pub. No.: US 2016/0232060 A1
(43) Pub. Date: Aug. 11, 2016

(54) EXCLUDING FILE SYSTEM OBJECTS FROM RAW IMAGE BACKUPS

(71) Applicant: HEWLETT PACKARD ENTERPRISE DEVELOPMENT LP, Houston, TX (US)

(72) Inventor: Mandar Nanivadekar, Bangalore, Karnataka (IN)

(21) Appl. No.: 15/021,534

(22) PCT Filed: Sep. 27, 2013
(86) PCT No.: PCT/US2013/062275

§ 371 Date: Mar. 11, 2016

(51) Int. Cl. G06F 11/14; G06F 17/30

(52) U.S. Cl. CPC G06F 11/1451; G06F 17/30233; G06F 17/30117; G06F 2201/80

(57) ABSTRACT

Techniques associated with excluding file system objects from raw image backups are described in various implementations. In one example, a method may include generating a virtual volume that comprises a replica of a source volume to be backed up, and providing file system access to the virtual volume. The method may also include receiving file system commands to remove specified file system objects from the virtual volume, and storing modified blocks that result from the file system commands to remove the specified file system objects. The method may also include performing a raw image backup to back up the source volume using unmodified blocks from the source volume and the stored modified blocks, such that the raw image backup excludes the specified file system objects.

### BACKGROUND

Many companies place a high priority on the protection of data. In the business world, the data that a company collects and uses is often the company's most important asset, and even a relatively small loss of data or data outage may have a significant impact. In addition, companies are often required to safeguard their data in a manner that complies with various data protection regulations. As a result, many companies have made sizeable investments in data protection and data protection strategies.

As one part of a data protection strategy, many companies perform backups of portions or all of their data. Data backups may be executed on an as-needed basis, but more typically are scheduled to execute on a recurring basis (e.g., nightly, weekly, or the like). Such data backups may serve different purposes. For example, one purpose may be to allow for the recovery of data that has been lost or corrupted. Another purpose may be to allow for the recovery of data from an earlier time—e.g., to restore previous versions of files and/or to restore a last known good configuration.

### BRIEF DESCRIPTION OF THE DRAWINGS

FIG. 1 is a conceptual block diagram of an example raw image backup process that excludes specified file system objects in accordance with implementations described herein.

FIG. 2 is a block diagram of an example backup environment in accordance with implementations described herein.

FIG. 3 is a flow diagram of an example process for backing up a source volume in accordance with implementations described herein.

FIG. 4 is a block diagram of an example computer system in accordance with implementations described herein.

### DETAILED DESCRIPTION

Computer systems often store data in file systems, which maintain data in a logical arrangement of files and directories. The files and directories contained within a file system may be organized in a hierarchical or other appropriate manner. In some cases, the files and directories of a file system may be backed up to a backup storage system to protect the files and directories in case of a fault or other condition that may cause data loss at the computer system. In the ensuing discussion, files and/or directories of a file system may generally be referred to as “file system objects”.

Two common approaches for backing up file systems and file system objects include file system backups and raw image backups. File system backups may generally be performed by walking the entire file system, processing each of the files in the file system (e.g., by opening, reading, and closing each file), gathering metadata for each of the files, and performing other actions to maintain the file system structure in the backup. Such processing, especially for relatively large file systems, may incur significant overhead in terms of backup time and storage space.

Raw image backups may, in many cases, be completed faster than corresponding file system backups, and may also require less storage space than similar file system backups. Raw image backups may generally be performed by transferring the underlying data from a file system block by block (as a raw image) to a backup storage system without necessarily maintaining the file system structure at the backup storage system. The raw image backup process bypasses the file system, and instead accesses a mount point (entry point to the file system) and backs up data from the mount point, block by block, as raw data. In this context, the term “block” refers to a specific physical area on a disk.

Although raw image backups provide certain advantages when compared to file system backups, raw image backups have not traditionally allowed for specified file system objects from the file system being backed up to be excluded from the raw image backup. Such functionality may be useful, for example, to ensure that certain files (e.g., system files, registry files, temporary files, or other specified files) are not backed up along with the rest of the file system objects. These files may, for example, represent data that is meaningless to a restore host, and in some cases may even cause the restore host to be unusable upon restoration. Other types of files that may be beneficial to exclude from being backed up may include, for example, kernel dumps, page files, system hibernation files, vendor-specific files, or others.

Described herein are techniques for performing raw image backups in a manner that allows specified file system objects to be excluded from the raw image backup to be performed. As used herein, the phrase “excluding a file system object” and other similar terminology generally refers to removing a record of the file system object, e.g., from a file system table that describes where (e.g., on which block or blocks) the various file system objects are physically stored, which effectively excludes the file system object from being recognized by a restore host. However, it should be understood that the underlying blocks themselves are not necessarily removed.

According to the techniques described here, a backup application may generate a virtual volume that is a mirror of the source volume to be backed up. The virtual volume may be presented to the local file system as a physical volume, and file system commands may be provided to simulate the removal of the specified file system objects from the virtual volume. For example, a backup process may issue appropriate file system delete commands causing certain files to be removed from the virtual volume (e.g., the files to be excluded from the backup, such as kernel dumps, system hibernation files, and/or other appropriate file system objects). In turn, the commands may cause certain blocks, e.g., the blocks associated with the specified files (e.g., in the file system table), to be modified on the virtual volume, and the modified blocks may be stored. The raw image backup may then be performed using a combination of the stored, modified blocks and the unmodified blocks from the source volume, such that the raw image backup excludes the specified file system objects.

Such techniques may be platform- and file system-agnostic, and may be used to back up a live, in-use source volume (e.g., without taking the source volume offline). The techniques may be performed without significant redundancy of storage requirements as most of the blocks necessary for the raw image backup may be taken from the source volume, and only modified blocks associated with file system objects to be excluded (e.g., modified blocks of the file system table) are additionally stored. These and other possible benefits and advantages will be apparent from the figures and from the description that follows.

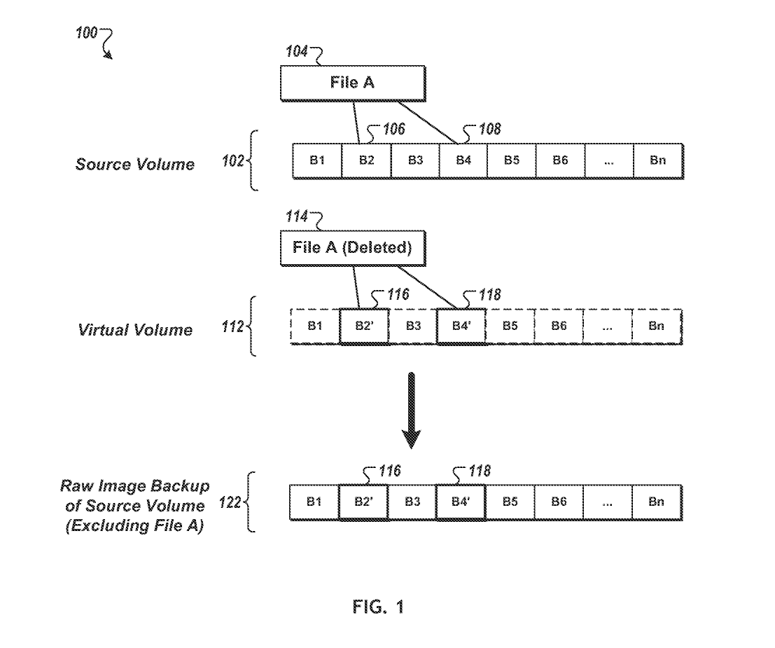

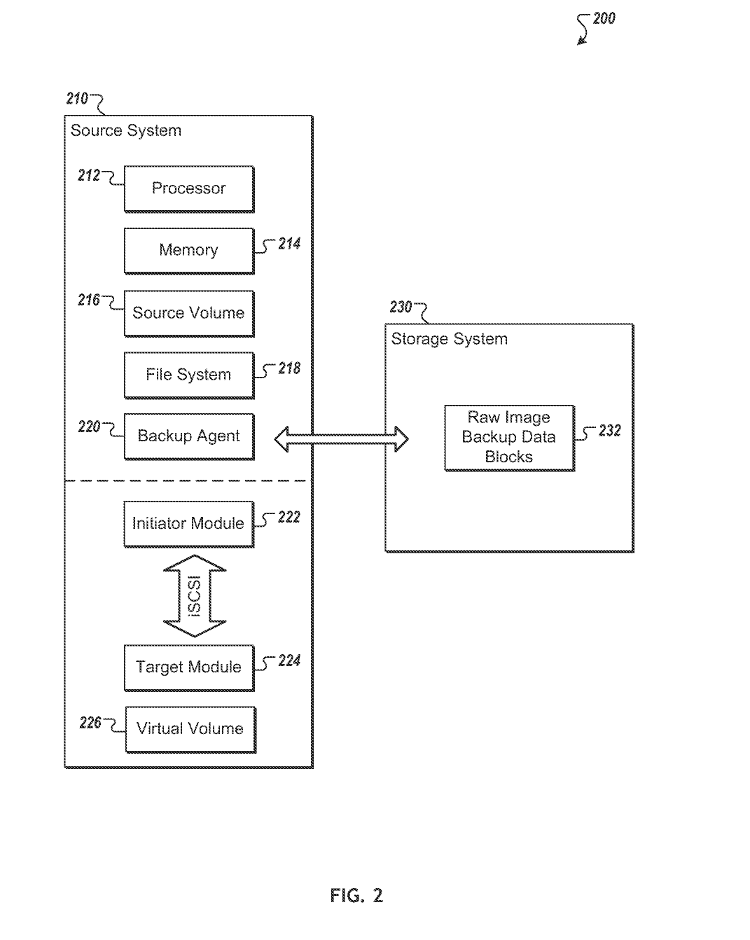

FIG. 1 is a conceptual block diagram of an example raw image backup process 100 that excludes specified file system objects in accordance with implementations described herein. The block diagram shows, conceptually, how a source volume 102 is backed up as a raw image 122 that excludes certain specified files from the source volume 102. The process 100 may be performed, for example, by a computing system such as the source system 210 illustrated in FIG. 2 and described in detail below. However, it should be understood that another system, or combination of systems, may also or alternatively be used to perform the process or various portions of the process.

In source volume 102, various files and directories of the file system, including a file system table, may be stored in underlying blocks of data, shown here as blocks B1, B2, B3, B4, B5, B6, and so on up to block Bn. In a traditional raw image backup, all of the blocks may be copied and stored, as is, on a block-by-block basis as raw data (e.g., without regard for what each of the blocks of data represents). Because the backup system performing the backup may only recognize a range of blocks to be copied and backed up, and may not interpret or otherwise understand the logical structure of the file system, specific file system objects from the file system cannot traditionally be targeted for exclusion from the raw image backup without removing the file system objects from the source volume 102 itself (e.g., before the backup is performed) or otherwise affecting the source volume 102. Such removal of the file system objects from the source volume 102 before performing the raw image backup may not be practical, such as in cases where the source volume 102 is live, and/or in-use. Similarly, mounting a raw image backup that includes undesired file system objects and removing such objects on restore may also be impractical in some cases.

As such, according to the raw image backup techniques described here, a virtual volume 112 may be generated, e.g., based on a live and in-use source volume 102. The virtual volume 112 may initially represent an exact mirror or replica of the source volume 102. The virtual volume 112 may be “virtual” in the sense that it may not utilize storage separate from the source volume 102, and instead may refer back to the blocks stored in source volume 102 for purposes of the backup. The dashed line representation of blocks B1, B3, B5, B6, etc. associated with virtual volume 112 is intended to show that such blocks are not physically stored separately from the blocks that are stored as part of the source volume 102. In some implementations, the virtual volume 112 may be generated, e.g., in memory by a source host agent on a source host, as an Internet Small Computer System Interlace (iSCSI) target, which may provide a platform- and file system-agnostic mirror of the source volume 102.

The virtual volume 112 may be presented to a source computing system in a manner that provides file system access to the virtual volume 112, e.g., by mounting the virtual volume as a physical volume that is accessible by the local file system. In some cases, the virtual volume 112 may be locked to ensure that other entities, apart from the backup process described herein, are prevented from accessing the virtual volume 112. Once file system access has been provided in such a manner, the backup process may issue appropriate file system commands to remove specific file system objects from the virtual volume 112. For example, if a user, such as a backup administrator or other appropriate user, wishes to exclude one or more kernel dumps, page files, system hibernation files, vendor-specific files, OF other such files from being backed up in the raw image backup of the source volume 102, the user may identify such files to the backup process (e.g., in a list of file system objects to be excluded, or in a policy describing which files system objects or types of file system objects are to be excluded), and the backup process may execute appropriate file system commands (e.g., using file system application programming interfaces (APIs) or other appropriate interlaces) to simulate deletion of the specified files from the virtual volume 112.

The simulated deletion of the one or more specified files may, in turn, cause a modification of certain blocks on the virtual volume 112 (e.g., the blocks of the file system table that are associated with the file system objects that have been targeted for removal). In the example as illustrated, the backup process has issued file system removal commands directed to a specific file, File A 104. When such file system removal commands are received, the blocks B2 106 and B4 108 that are associated with File A 104 on the virtual volume 112 may be modified to reflect the removal of File A. The modified versions of blocks B2 106 and B4 108 are shown as B2′ 116 and B4′ 118, respectively, which correspond to modifications reflecting the deletion of File A 114 on the virtual volume 112. Such modified blocks B2 116 and B4′ 118 may be captured and stored (e.g., in a memory resource, or in a dedicated storage resource) in association with the virtual volume 112, as shown by the solid line (rather than dashed line) representation of such blocks.

As shown, the example illustrates the removal from the virtual volume 112 of only a single file system object, but it should be understood that additional file system objects or groups of file system objects may similarly be specified for removal from the virtual volume 112, thus causing additional block modifications similar to those described above.

When all of the desired file system objects have been removed from the virtual volume 112, the raw image backup may be performed in a manner such that the specified (e.g., removed) file system objects are excluded from the raw image backup. For example, the raw image backup process may identify all of the modified blocks stored in association with the virtual volume 112, and copy those modified blocks as part of the raw image 122, and the remaining unmodified blocks may be copied from the original blocks from source volume 102 to be used in the raw image 122. In the illustrated example, the modified blocks B2′ 116 and B4′ 118 may be stored in place of B2 106 and B4 108 in the raw image 122, but the remaining blocks of source volume 102 may be copied as is. In such a manner, the source volume 102 may be backed up and stored as a consistent raw image backup of the source volume 102, but excluding certain specified files.

FIG. 2 is a block diagram of an example backup environment 200 in accordance with implementations described herein. As shown, the example backup environment 200 includes a source system 210 communicatively coupled to a storage system 230. The source system 210 may be located in a particular location, such as in a data center, while the storage system 230 may be located in a different physical location (or locations), such as the cloud. The source system 210 and the storage system 230 may each be implemented as any appropriate single computing device (e.g., servers, workstations, desktop computers, or the like) or as groups of appropriate computing devices. The storage system 230 may be implemented with one or multiple storage devices to store various types of appropriate data, such as raw image backup data blocks 232, which may be transferred from the source system 210 to complete a backup operation.

The example topology of environment 200 may be representative of various backup environments. However, it should be understood that the example topology of environment 200 is shown for illustrative purposes only, and that various modifications may be made to the configuration. For example, in some implementations, multiple devices and/or components, or the functionalities associated with such devices and/or components, may be combined, distributed, or otherwise implemented in a different manner than is shown. Similarly, while shown as separate computing systems, source system 210 and storage system 230 (or portions of such systems) may be integrated into a single computing system, which may be co-located, for example, in a data center. Also, while not shown, the environment 200 may also include a separate backup system communicatively coupled to the source system 210 and the storage system 230, which may facilitate backup and/or restore operations associated with such systems.

Source system 210 may include a processor resource 212, a memory resource 214, a source volume 216, a file system 218, and a backup agent 220. It should be understood that the components shown here are for illustrative purposes, and that in some cases, the functionality being described with respect to a particular component may be performed by one or more different or additional components. Similarly, it should be understood that portions or all of the functionality may be combined into fewer components than are shown.

Processor resource 212 may be configured to process instructions for execution by source system 210. The instructions may be stored on a non-transitory, tangible computer-readable storage medium, such as in memory resource 214 or on a separate storage resource (not shown), or on any other type of volatile or non-volatile memory that stores instructions to cause a programmable processor to perform the techniques described herein. Alternatively or additionally, source system 210 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, the processor resource 212 may include multiple processors and/or types of processors, and the memory resource 214 may include multiple memories and/or types of memory.

Source volume 216 may contain file system objects, such as files and directories, and may be stored in an appropriate storage resource (not shown) of source system 210. The file system objects included in the source volume 216 may be maintained and managed by a file system 218, which may include data structures used for organizing the file system objects in a logical manner. For example, the file system 218 may include a hierarchical tree structure, or other appropriate structure, in which the file system objects may be arranged at different hierarchical levels. The file system 218 may also provide one or more interfaces (such as file system APIs) for accessing the file system objects in the source volume 216.

Backup agent 220 may be configured to manage various backup operations associated with the source system 210. For example, backup agent 220 may be configured to cause the source volume 216 to be backed up in accordance with the techniques described herein. In various implementations, the backup agent 220 may include, for example, a hardware device including electronic circuitry for implementing the functionality described herein, such as backup control logic and/or memory. In addition, or alternatively, the backup agent 220 may be implemented as a series of instructions encoded on a machine-readable storage resource comprising one or more machine-readable storage medium/media, and executable by a processing resource, such as processor resource 212.

In response to a raw image backup request, the backup agent 220 may determine whether specified file system objects are to be excluded from the raw image backup. If not, the backup agent 220 may perform traditional raw image backup processing to copy the source volume 216, block by block, to generate a raw image, which may be communicated to the storage system 230 and stored as raw image backup data blocks 232.

If the raw image backup is to exclude specified file system objects, the backup agent 220 may generate an initiator module 222 and a target module 224, and the target module 224 may be used to generate a virtual volume 226. In some implementations, the initiator module 222 may perform the functionality of an iSCSI initiator, and the target module 224 may facilitate access to an iSCSI target volume. In such implementations, the initiator module 222 may connect to and communicate with the target module 224 using appropriate iSCSI protocols, and the virtual volume 226 may be exposed to the file system as an iSCSI target volume. In other implementations, filter drivers may be used to perform the functionality described in association with the initiator module 222 and/or the target module 224.

The virtual volume 226 may initially represent a virtualized mirror or replica of source volume 216. The initiator module 222 and the target module 224 may work in combination to make the virtual volume 226 accessible to the file system 218. For example, the virtual volume 226 may be mounted as a physical volume accessible by the file system 218. In some implementations, the initiator module 222 and target module 224 may be used to enforce control and security of the virtual volume 226 to ensure that unauthorized entities are prevented from accessing the virtual volume 226.

After file system access has been provided to the virtual volume 226, the backup agent 220 may issue appropriate file system commands to remove specific file system objects from the virtual volume 226. For example, the backup agent 220 may cause the initiator module 222 to send appropriate commands to the target module 224 requesting that specified file system objects be removed from the virtual volume 226.

The removal of the one or more specified files from the virtual volume 226 may, in turn, cause a modification of certain blocks on the virtual volume 226 (e.g., the blocks of the file system table that are associated with the file system objects that have been targeted for removal). The target module 224 may capture and store the modified blocks in association with the virtual volume 226. The modified blocks may be stored, for example, in the memory resource 214 or in a separate storage resource (not shown). In some implementations, the raw image backup techniques described herein may be performed in parallel, e.g., at the same time for multiple source volumes. In such implementations, the modified blocks from the parallel backup procedures may be maintained and stored separately, with appropriate associations to the respective volumes that are being backed up.

When all of the specified file system objects have been removed from the virtual volume 226, the backup agent 220 may perform raw image backup procedures in a manner such that the specified (e.g., removed) file system objects are excluded from the raw image backup. For example, the backup agent 220 may identify all of the modified blocks stored in association with the virtual volume 226, and copy those modified blocks as part of the raw image, and the remaining unmodified blocks may be copied from source volume 216 for use in the raw image.

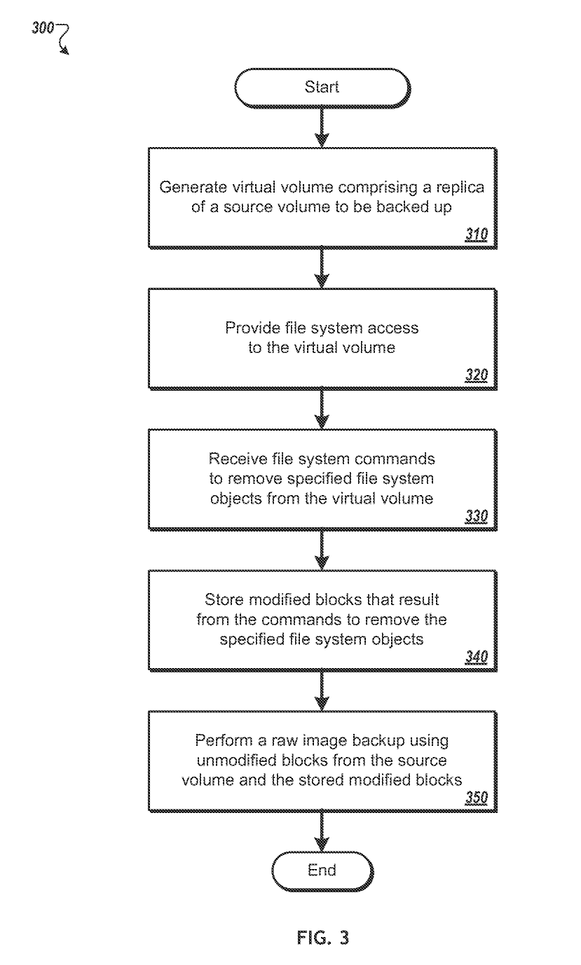

FIG. 3 is a flow diagram of an example process 300 for backing up a source volume in accordance with implementations described herein. The process 300 may be performed, for example, by a computing system such as the source system 210 illustrated in FIG. 2. For clarity of presentation, the description that follows uses the source system 210 illustrated in FIG. 2 as the basis of an example for describing the process. However, it should be understood that another system, or combination of systems, may be used to perform the process or various portions of the process.

Process 300 begins at block 310, when a virtual volume comprising a replica of a source volume to be backed up is generated. For example, the source system 210 may generate a virtual volume that initially represents an exact mirror or replica of the source volume. In some implementations, the virtual volume may be generated in a memory associated with the source system.

At block 320, file system access is provided to the virtual volume. For example, the virtual volume may be presented as a physical volume that is accessible by a local file system. The file system access may allow a backup process to issue appropriate file system commands directed to file system objects associated with the virtual volume. In some cases, such file system access to the virtual volume may be locked to prevent unauthorized entities from accessing the virtual volume. In some implementations, the virtual volume may be generated (310) and provided (320) as an iSCSI target, and locking the virtual volume may include implementing appropriate iSCSI protocols to enforce security and/or control of the virtual volume.

At block 330, file system commands to remove specified file system objects from the virtual volume are received. For example, a backup process with the appropriate permissions may issue file system commands (e.g., delete commands or other similar commands) to remove specified file system objects from the virtual volume. Such file system commands may be used to simulate deletion of one or more kernel dumps, page files, system hibernation files, vendor-specific files, or other appropriate file system objects. The file system commands may be issued, for example, by way of exposed file system APIs or other appropriate interfaces.

At block 340, modified blocks that result from the commands to remove the specified file system objects are stored. The modified blocks may be modified versions of corresponding blocks from the source volume, with the modified versions reflecting removal of the specified file system objects. In implementations where virtual volume is generated and provided as an iSCSI target, the modified blocks may be captured and stored by the iSCSI target.

At block 350, a raw image backup using unmodified blocks from the source volume and the stored modified blocks is performed. For example, after the backup process has specified all of the file system objects that are to be removed from the virtual volume, the raw image backup may be performed in a manner such that the specified (e.g., removed) file system objects are excluded from the raw image backup. In some implementations, the raw image backup process may identify all of the modified blocks stored in association with the virtual volume, and copy those modified blocks as part of the raw image, and the remaining unmodified blocks may be copied from the source volume. As such, the combination of unmodified blocks (from the source volume) and modified blocks (as captured in association with the virtual volume) may be used to generate a consistent raw image backup of the source volume that excludes certain specified files.

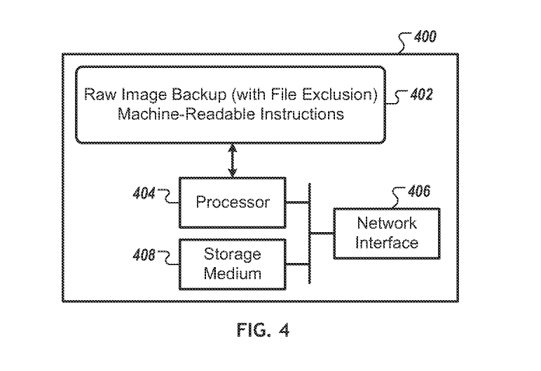

FIG. 4 is a block diagram of an example computer system 400 in accordance with implementations described herein. The system 400 includes raw image backup machine-readable instructions 402, which may be configured to implement certain of the various modules of the computing systems depicted in FIG. 2, or to perform portions or all of the processes described in FIGS. 1 and/or 3. The raw image backup machine-readable instructions 402 may be loaded for execution on a processor 404 or on multiple processors, which may collectively be referred to as a processor resource. In some implementations, the instructions 402, when executed by the processor resource, may cause the processor resource to generate a virtual volume that comprises a replica of a source volume to be backed up, to provide file system access to the virtual volume, to receive file system commands to remove specified file system objects from the virtual volume, to store modified blocks that result from the file system commands to remove the specified file system objects from the virtual volume, and to perform a raw image backup to back up the source volume using unmodified blocks from the source volume and the stored modified blocks, such that the raw image backup excludes the specified file system objects.

As used herein, a processor resource may include a microprocessor, microcontroller, processor module or subsystem, programmable integrated circuit, programmable gate array, or another control or computing device. The processor(s) 404 may be coupled to a network interface 406 (to allow the system 400 to perform communications over a data network) and/or to a storage medium (or storage media) 408.

The storage medium 408 may be implemented as one or multiple computer-readable or machine-readable storage media. The storage media may include different forms of memory including semiconductor memory devices such as dynamic or static random access memories (DRAMs or SRAMs), erasable and programmable read-only memories (EPROMs), electrically erasable and programmable read-only memories (EEPROMs), and flash memories; magnetic disks such as fixed, floppy and removable disks; other magnetic media including tape; optical media such as compact disks (CDs) or digital video disks (DVDs); or other appropriate types of storage devices.

Note that the instructions discussed above may be provided on one computer-readable or machine-readable storage medium, or alternatively, may be provided on multiple computer-readable or machine-readable storage media (e.g., in a distributed system having plural nodes). Such computer-readable or machine-readable storage media are considered to be part of an article (or article of manufacture). An article or article of manufacture may refer to any appropriate manufactured component or multiple components. The storage medium or media may be located either in the machine running the machine-readable instructions, or located at a remote site, e.g., from which the machine-readable instructions may be downloaded over a network for execution.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is:

1. A method comprising:
generating, using a computing system, a virtual volume that comprises a replica of a source volume to be backed up;
providing, using the computing system, file system access to the virtual volume;
receiving, using the computing system, the system commands to remove specified file system objects from the virtual volume;
storing, using the computing system, modified blocks that result from the file system commands to remove the specified file system objects from the virtual volume; and
performing, using the computing system, a raw image backup to back up the source volume using unmodified blocks from the source volume and the stored modified blocks, such that the raw image backup excludes the specified file system objects.

2. The method of claim 1, wherein the modified blocks are modified versions of corresponding blocks from the source volume, the modified versions reflecting removal of the specified file system objects.

3. The method of claim 1, wherein providing the file system access to the virtual volume includes presenting the virtual volume as a physical volume accessible by a local file system.

4. The method of claim 1, wherein the virtual volume is generated and provided by an Internet Small Computer System Interface (iSCSI) target module.

5. The method of claim 4, wherein the modified blocks are captured and stored by the iSCSI target module.

6. A system comprising:
a processor resource; and
a backup agent, executable on the processor resource, wherein the backup agent:
causes a virtual volume to be generated, the virtual volume comprising a replica of a source volume to be backed up,
causes commands to be issued, the commands requesting removal of specified file system objects from the virtual volume,
causes modified blocks from the virtual volume to be stored, the modified blocks resulting from the issued commands, and
causes a raw image backup operation to be performed, the raw image backup operation backing up the source volume using unmodified blocks from the source volume and the modified blocks, such that the raw image backup excludes the specified file system objects.

7. The system of claim 6, wherein the modified blocks are modified versions of corresponding blocks from the source volume, the modified versions reflecting removal of the specified file system objects.

8. The system of claim 6, wherein the backup agent causes the virtual volume to be presented as a physical volume accessible by a local file system.

9. The system of claim 8, wherein the virtual volume is generated and presented by an Internet Small Computer System Interface (iSCSI) target module.

10. The system of claim 9, wherein the modified blocks are captured and stored by the iSCSI target module.

11. A non-transitory, computer-readable storage medium storing instructions that, when executed by a processor resource, cause the processor resource to:
generate a virtual volume that comprises a replica of a source volume to be backed up;
provide file system access to the virtual volume;
receive file system commands to remove specified file system objects from the virtual volume;
store modified blocks that result from the file system commands to remove the specified file system objects from the virtual volume; and
perform a raw image backup to back up the source volume using unmodified blocks from the source volume and the stored modified blocks, such that the raw image backup excludes the specified file system objects.

12. The non-transitory, computer-readable storage medium of claim 11, wherein the modified blocks are modified versions of corresponding blocks from the source volume, the modified versions reflecting removal of the specified file system objects.

13. The non-transitory, computer-readable storage medium of claim 11, wherein providing the file system access to the virtual volume includes presenting the virtual volume as a physical volume accessible by a local file system.

14. The non-transitory, computer-readable storage medium of claim 11, wherein the virtual volume is generated and provided by an Internet Small Computer System Interface (iSCSI) target module.

15. The non-transitory, computer-readable storage medium of claim 14, wherein the modified blocks are captured and stored by the iSCSI target module.
